(19) United States
(12) Patent Application Publication
(10) Pub. No.: US 2009/0029211 A1
(43) Pub. Date: Jan. 29, 2009

(54) FUEL CELL SYSTEM WITH SERIES-PARALLEL CIRCUIT

(75) Inventors: Ming-Yao Dong, ChuPei City (TW); Chun-Chin Tung, ChuPei City (TW)

Correspondence Address: NIKOLAI & MERSEREAU, P.A., 900 SECOND AVENUE SOUTH, SUITE 820, MINNEAPOLIS, MN, 55402, US

(73) Assignee: Syspotek Corporation, ChuPei City (TW)

(21) Appl. No.: 12/174,220

(22) Filed: Jul. 16, 2008

(30) Foreign Application Priority Data
Jul. 25, 2007 (CN) 200710130048.8

(51) Int. Cl. H01M 8/04

(52) U.S. Cl. 429/23

(57) ABSTRACT

The present invention relates to a fuel cell system with series-parallel circuit, comprising a plurality of fuel cell stacks and a series-parallel circuit unit. Each fuel cell stack contains. DC power output terminals, and the series-parallel circuit unit consists of a plurality of parallel mode selection units and DC power output terminals. The DC power output terminal of respective fuel cell stack is electrically connected to the corresponding parallel mode selection unit in the series-parallel circuit unit. The parallel mode selection units are electrically parallel-connected to the DC power output terminal of the series-parallel circuit unit. The parallel mode selection unit selects whether the DC power output terminal of the corresponding fuel cell stack and the DC power output terminal of the series-parallel circuit unit are electrically connected or disconnected.

### FIELD OF THE INVENTION

The present invention relates to a fuel cell system with series-parallel circuit, particularly a kind of fuel cell system that provides control over the electrical series-parallel connection and power output of a plurality of fuel cell stacks.

### BACKGROUND OF THE INVENTION

Convention fuel cell uses hydrogen and oxygen to undergo electrochemical reaction. It is an emerging energy source that provides electric power. Fuel cells commonly go through DC voltage conversion to control the output voltage for power supply. With respect to the means of DC voltage conversion, excessive voltage conversion ratio or improper conversion range tends to increase power loss. Moreover, if the fuel cell adopts multi-stage voltage conversion, it would jack up its cost while the range of voltage conversion is still limited.

There are also fuel cell systems that integrate the power of a plurality of fuel cells through simple means of series-connection or parallel-connection and output power with specific voltage or current. But this type of fuel cell system must go through another DC voltage conversion in order to obtain power of desired characteristics.

In light of the drawbacks of conventional fuel cell system, the inventor aims to develop a fuel cell system with series-parallel circuit.

### SUMMARY OF THE INVENTION

The object of the invention is to provide a fuel cell system with series-parallel circuit, which integrates a plurality of fuel cell stacks via a specific series-parallel circuit such that all parallel-connected fuel cell stacks are co-grounded.

Another object of the invention is to provide a fuel cell system with series-parallel circuit, characterized in which after a plurality of fuel cell stacks in the fuel cell system have undergone voltage conversion, their powers are integrated by a specific series-parallel circuit and effectively output with the characteristics that meet specific power demands, and the fuel cell system provides wider range of voltage conversion.

Yet another object of the invention is to provide a fuel cell system with series-parallel circuit, which can, by controlling the conversion of respective voltage output by a plurality of fuel cell stacks, regulate the characteristics of output voltage or current that has passed through the series-parallel circuit.

To achieve the aforesaid objects, the invention provides a fuel cell system with series-parallel circuit, comprising a plurality of fuel cell stacks and a series-parallel circuit unit, each fuel cell stack containing DC power output terminals, and the series-parallel circuit unit consisting of a plurality of parallel mode selection units and DC power output terminals. The DC power output terminal of respective fuel cell stack is electrically connected to the corresponding parallel mode selection unit in the series-parallel circuit unit. The parallel mode selection units are electrically parallel-connected to the DC power output terminal of the series-parallel circuit unit. The respective parallel mode selection unit selects whether the DC power output terminal of the corresponding fuel cell stack and the DC power output terminal of the series-parallel circuit unit are electrically connected or disconnected.

The objects, features and effects of the invention are described in detail below with embodiments in reference to the accompanying drawings.

### BRIEF DESCRIPTION OF THE DRAWINGS

FIG. 1 is a component diagram of a fuel cell system with series-parallel circuit according to a first embodiment of the invention;

FIG. 2 is a component diagram of a fuel cell system with series-parallel circuit according to a second embodiment of the invention;

FIG. 3 is a component diagram of a fuel cell system with series-parallel circuit according, to a third embodiment, of the invention;

FIG. 4 is a component diagram of a fuel cell system with series-parallel circuit according to a fourth embodiment of the invention;

FIG. 5 is a component diagram of a fuel cell system with series-parallel circuit according to a fifth embodiment of the invention; and

FIG. 6 is a component diagram of a fuel cell system with series-parallel circuit according to a sixth embodiment of the invention.

### DETAILED DESCRIPTION OF THE INVENTION

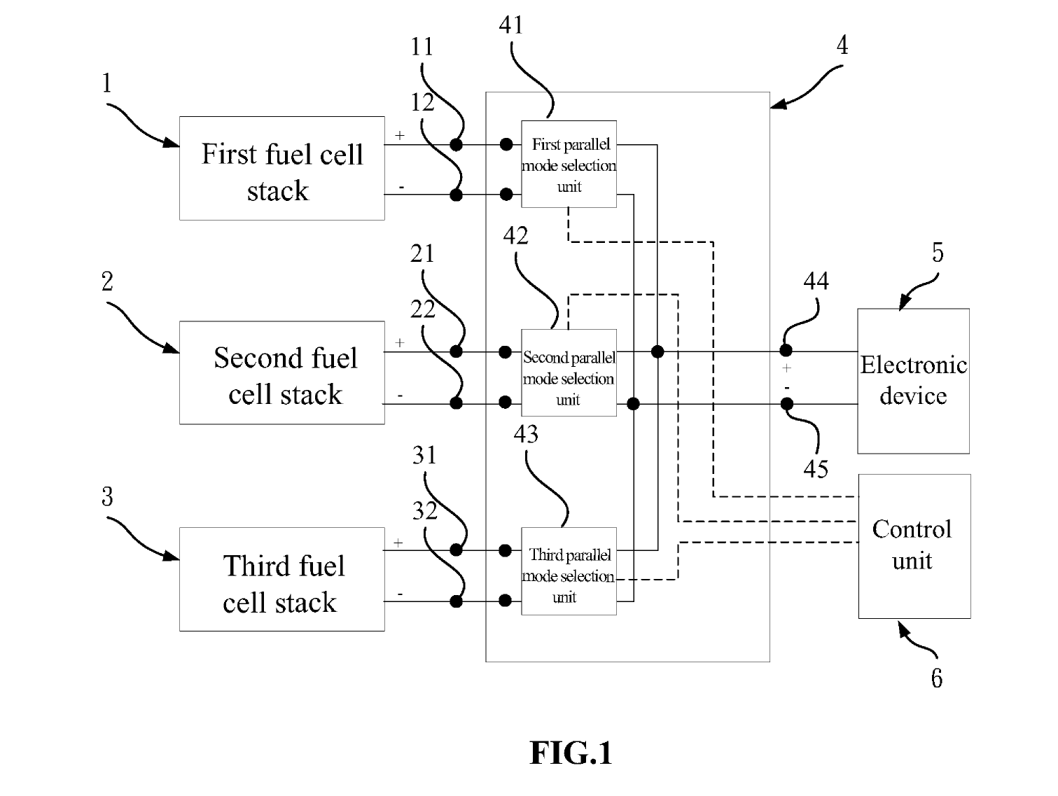

FIG. 1 is a component diagram of a fuel cell system with series-parallel circuit according to a first embodiment of the invention. The fuel cell system with series-parallel circuit comprises a plurality of fuel cell stacks including a first fuel cell stack (1), a second fuel cell stack (2), and a third fuel cell stack (3), which are electrically connected through a series-parallel circuit unit (4). The series-parallel circuit unit (4) is electrically connected to an electronic device (5) such that the power generated by the fuel cell stacks can be transmitted to the electronic device (5).

In the fuel cell system with series-parallel circuit of the invention, the first fuel cell stack (1) contains DC power output terminals, the DC power output terminals consisting of a first positive DC power output terminal (11) and a first negative DC power output terminal (12). The first positive DC power output terminal (11) and the first negative DC power output terminal (12) are respectively the cathode and the anode of the DC power of the first fuel cell stack (1). The first fuel cell stack (1) is electrically connected to the series-parallel circuit unit (4) via the first positive DC power output terminal (11) and the first negative DC power output terminal (12). The second fuel cell stack (2) contains DC power output terminals, the DC power output terminals consisting of a second positive DC power output terminal (21) and a second negative DC power output terminal (22). The second positive DC power output terminal (21) and the second negative DC power output terminal (22) are respectively the cathode and the anode of the DC power of the second fuel cell stack (2), and the second fuel cell stack (2) is electrically connected to the series-parallel circuit unit (4) through the second positive DC power output terminal (21) and the second negative DC power output terminal (22). The third fuel cell stack (3) contains DC power output terminals, the DC power output terminals consisting of a third positive DC power output terminal (31) and a third negative DC power output terminal (32). The third positive DC power output terminal (31) and the third negative DC power output terminal (32) are respectively the cathode and the anode of the DC power of the third fuel cell stack (3), and the third fuel cell stack (3) is electrically connected to the series-parallel circuit unit (4) through the third positive DC power output terminal (31) and the third negative DC power output terminal (32). The series-parallel circuit unit (4) comprises a plurality of parallel mode selection units and DC power output terminals. The parallel mode selection units include a first parallel mode selection unit (41), a second parallel mode selection unit (42), and a third parallel mode selection unit (43). The DC power output terminals of the series-parallel circuit unit (4) consist of a positive integrated DC power output terminal (44) and a negative integrated DC power output terminal (45). The first parallel mode selection unit (41), the second parallel mode selection unit (42), and the third parallel mode selection unit (43) are respectively electrically connected to the corresponding first fuel cell stack (1), the second fuel cell stack (2) and the third fuel cell stack (3), which are respectively electrically parallel-connected to the positive integrated DC power output terminal (44) and the negative integrated DC power output terminal (45) of the series-parallel circuit unit (4) via the first parallel mode selection unit (41), the second parallel mode selection unit (42), and the third parallel mode selection unit (43) such that the fuel cell stacks are electrically connected in parallel. In addition, the first parallel mode selection unit (41) selects whether the first positive DC power output terminal (11) of the first fuel cell stack (1) and the positive integrated DC power output terminal (44) are electrically connected or disconnected, or selects whether the first negative DC power output terminal (12) of the first fuel cell stack (1) and the negative integrated DC power output terminal (45) are electrically connected or disconnected. The second parallel mode selection unit (42) selects whether the second positive DC power output terminal (21) of the second fuel cell stack (2) and the positive integrated DC power output terminal (44) are electrically connected or disconnected, or selects whether the second negative DC power output terminal (22) of the second fuel cell stack (2) and the negative integrated DC power output terminal (45) are electrically connected or disconnected. The third parallel mode selection unit (43) selects whether the third positive DC power output terminal (31) of the third fuel cell stack (3) and the positive integrated DC power output terminal (44) are electrically connected or disconnected, or selects whether the third negative DC power output terminal (32) of the third fuel cell stack (3) and the negative integrated DC power output terminal (45) are electrically connected or disconnected. As such, in the fuel cell system with series-parallel circuit, the electrically parallel-connected fuel cell stacks are co-grounded, and the series-parallel circuit unit (4) can form a plurality of electrical channels, through which, the corresponding parallel mode selection unit could select open or closed circuit such that power from the fuel cell stacks could be integrated by the positive integrated DC power output terminal (44) and the negative integrated DC power output terminal (45) before being output to the electronic device (5) to supply power needed by the device.

The fuel cell system with series-parallel circuit above further comprises a control unit (6), the control unit (6) having a logic control means needed for the operation of the fuel cell system with series-parallel circuit and composed of a logic circuit or a chip coupled with firmware. The first parallel mode selection unit (41), the second parallel mode selection unit (42), and the third parallel mode selection unit (43) are respectively electrically connected to the control unit (6), where the control unit (6) controls the selection of the corresponding electrical channel being electrically open or closed by each parallel mode selection unit. Specifically, the control unit (6) is a microcontroller coupled with firmware that executes relevant computing through the firmware and is electrically connected to the controlled elements including the parallel mode selection units of the series-parallel circuit unit (4), thereby controlling the actions of those parallel mode selection units.

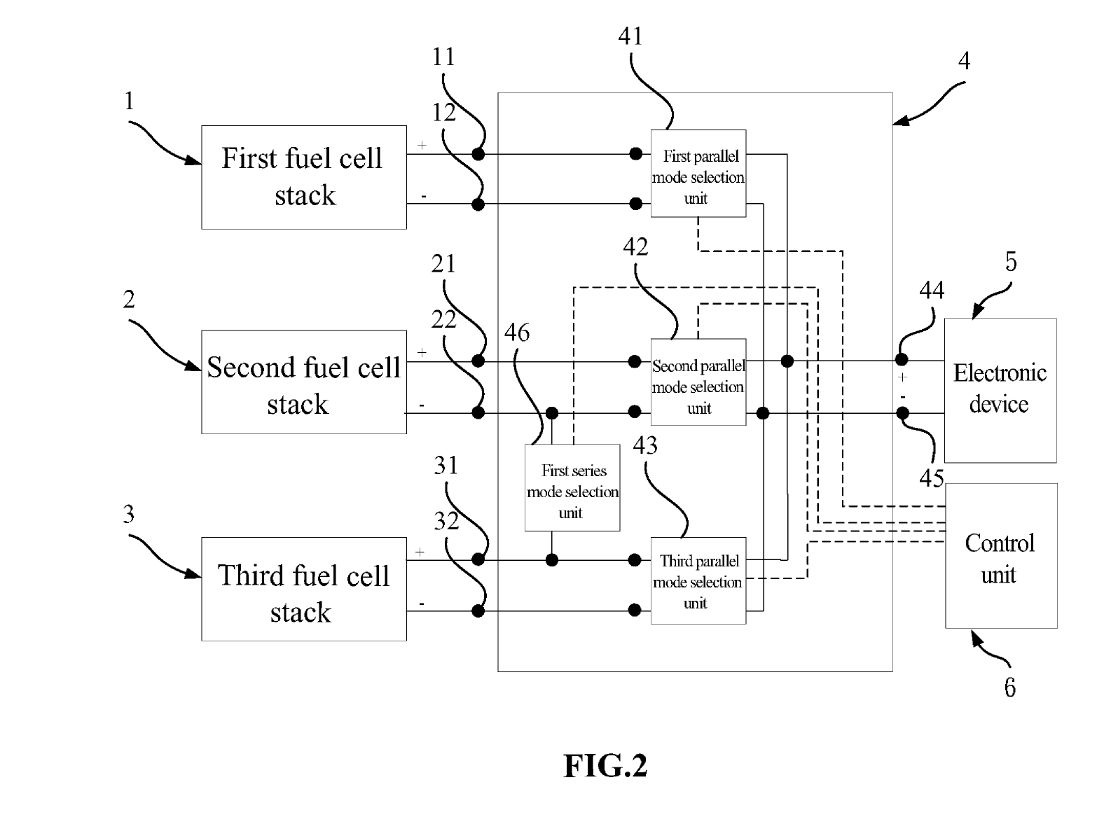

FIG. 2 is a component diagram of a fuel cell system with series-parallel circuit according to a second embodiment of the invention. The fuel cell system with series-parallel circuit in this embodiment further comprises a first series mode selection unit (46), the first series mode selection unit (46) selects whether two fuel cell stacks among the fuel cell stacks of the fuel cell system are electrically connected or disconnected, and selects whether the second fuel cell stack (2) and the third fuel cell stack (3) are electrically connected in series or in parallel in coordination with the actions of the second parallel mode selection unit (42) and the third parallel mode selection unit (43) corresponding respectively to the second fuel cell stack (2) and the third fuel cell stack (3). In a specific example, one end of the first series mode selection unit (46) is electrically connected to the second negative DC power output terminal (22) of the second fuel cell stack (2), while the other end is electrically connected to the third positive DC power output terminal (31) of the third fuel cell stack (3). In addition, the first series mode selection unit (46) selects whether the second negative DC power output terminal (22) of the second fuel cell stack (2) and the third positive DC power output terminal (31) of the third fuel cell stack (3) are electrically connected or disconnected; the second parallel mode selection unit (42) selects whether the second negative DC power output terminal (22) of the second fuel cell stack (2) and the negative integrated DC power output terminal (45) are electrically connected or disconnected; the third parallel mode selection unit (43) selects whether the third positive DC power output terminal (31) of the third fuel cell stack (3) and the positive integrated DC power output terminal (44) are electrically connected or disconnected; and the first series mode selection unit (46) is electrically connected to the control unit (6), where the control unit (6) controls the selection of the corresponding electrical channel being electrically open or closed by the first series mode selection unit (46).

Hence when the control unit (6) controls simultaneously the first series mode selection unit (46) to select the second negative DC power output terminal (22) of the second fuel cell stack (2) and the third positive DC power output terminal (31) of the third fuel cell stack (3) being electrically connected, the second parallel mode selection unit (42) to select the second negative DC power output terminal (22) of the second fuel cell stack (2) and the negative integrated DC power output terminal (45) being electrically disconnected, the third parallel mode selection unit (43) to select the third positive DC power output terminal (31) of the third fuel cell stack (3) and the positive integrated DC power output terminal (44) being electrically disconnected, and the first parallel mode selection unit (41) to select the first positive DC power output terminal (11) and the first negative DC power output terminal (12) of the first fuel cell stack (1) being electrically connected to the positive integrated DC power output terminal (44) and the negative integrated DC power output terminal (45) respectively, the second fuel cell stack (2) and the third fuel cell stack (3) form a series-connection, and the second positive DC power output terminal (21) of second fuel cell stack (2) and the third negative DC power output terminal (32) of the third fuel cell stack (3) in the series are respectively electrically connected to the positive integrated DC power output terminal (44) and the negative integrated DC power output terminal (45), such that the second positive DC power output terminal (21) of second fuel cell stack (2) and the third negative DC power output terminal (32) of the third fuel cell stack (3) in the series form a parallel connection with the first fuel cell stack (1).

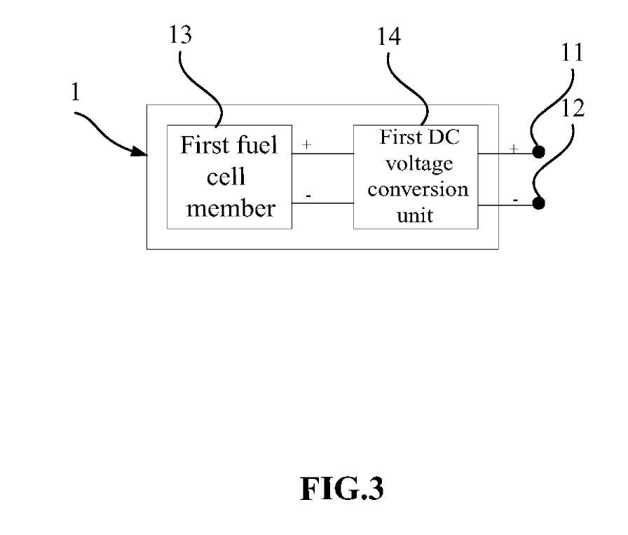

FIG. 3 is a component diagram of a fuel cell system with series-parallel circuit according to a third embodiment of the invention. In this embodiment, any fuel cell stack in the plurality of the fuel cell stacks could comprise a fuel cell member and a DC voltage conversion unit corresponding to the fuel cell member. The fuel cell member is a power generating member, which, through the input of hydrogen rich fuel and oxygen fuel and proper electrochemical reaction, could output DC power. The DC power conversion unit converts DC power into power with specific voltage for output. Specifically, the first fuel cell stack (1) consists of a first fuel cell member (13) and a first DC voltage conversion unit (14), the first fuel cell member (13) being electrically series-connected to the first DC voltage conversion unit (14). The first fuel cell stack (1) outputs power generated by the first fuel cell member (13) and undergone voltage conversion by the first DC voltage conversion unit (14) through its first positive DC power output terminal (11) and first negative DC power output terminal (12).

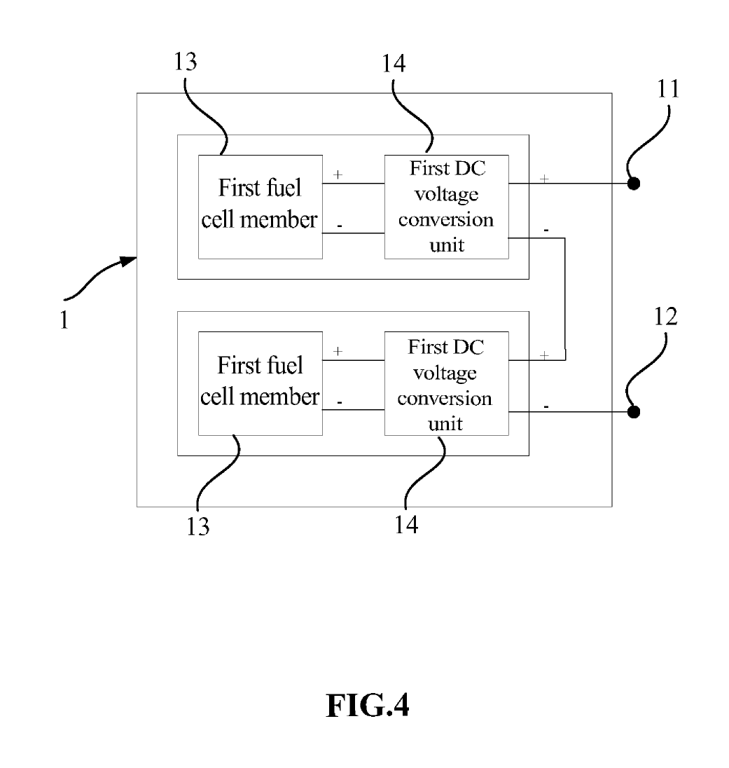

FIG. 4 is a component diagram of a fuel cell system with series-parallel circuit according to a fourth embodiment of the invention. In this embodiment, any fuel cell stack in the plurality of the fuel cell stacks could comprise a plurality of fuel cell members and a plurality of DC voltage conversion units corresponding to the fuel cell members. Each fuel cell member is a power generating members, which, through the input of hydrogen rich fuel and oxygen fuel and proper electrochemical reaction, could output DC power. Each DC power conversion unit could convert DC power into power with specific voltage for output. Specifically, the first fuel cell stack (1) consists of a plurality of first fuel cell members (13) and a plurality of first DC voltage conversion units (14), each first fuel cell member (13) being electrically series-connected to the corresponding first DC voltage conversion unit (14), and the DC power output terminals of respective first DC voltage conversion units (14) form a series connection. The first fuel cell stack (1) outputs integrated power generated by the first fuel cell members (13) and undergone voltage conversion by the first DC voltage conversion units (14) through its first positive DC power output terminal (11) and first negative DC power output terminal (12).

Hence through the design of electrical characteristics output by the fuel cell stacks, for example, having the first fuel cell stack (1), the second fuel cell stack (2) and the third fuel cell stack (3) output specific voltage, current or power respectively and connecting the fuel cell stacks electrically through the series-parallel circuit unit (4), an integrated electric power with specific voltage, current or power can be outputted to the electronic device (5). Specifically, the first fuel cell stack (1), the second fuel cell stack (2) and the third fuel cell stack (3) output power with different direct current such that the fuel cell system could output power with the sum of currents from respectively first fuel cell stack (1), second fuel cell stack (2) and third fuel cell stack (3) which are electrically parallel-connected via the series-parallel circuit unit (4). Output power with different electrical characteristics can be obtained by changing the series-parallel connection relationship among the fuel cell stacks.

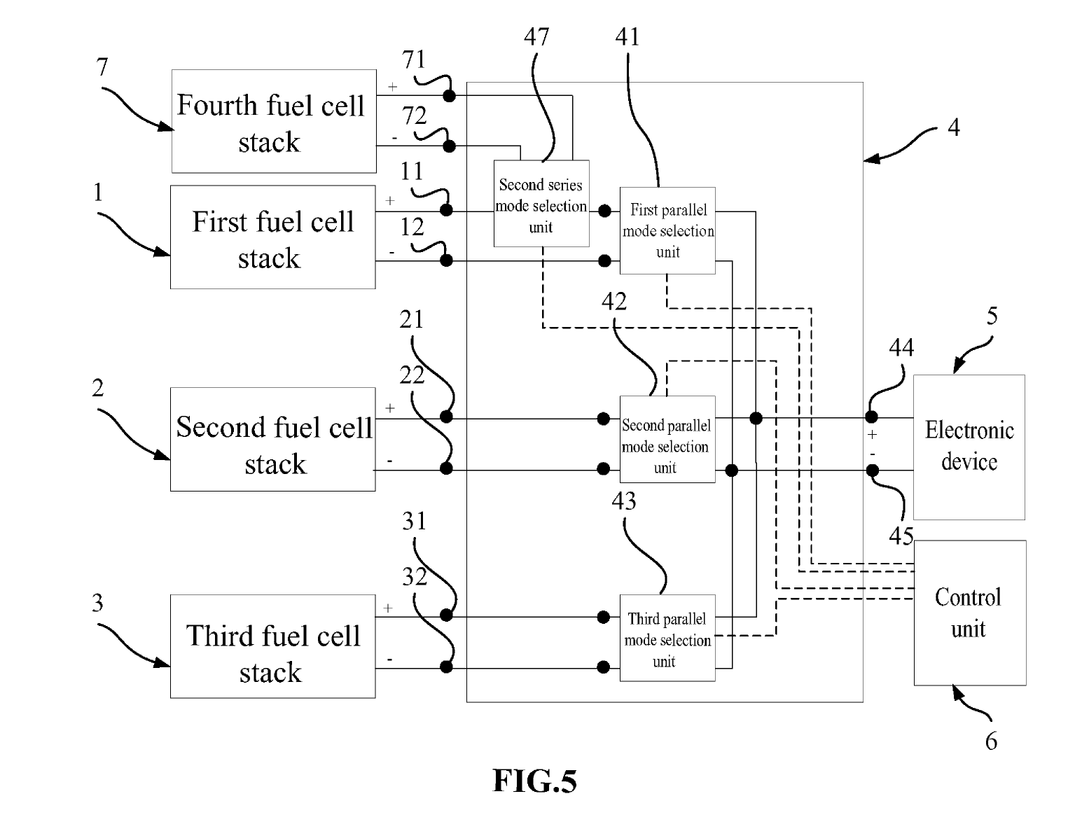

FIG. 5 is a component diagram of a fuel cell system with series-parallel circuit according to a fifth embodiment of the invention. In this embodiment, the fuel cell system with series-parallel circuit further comprises a fourth fuel cell stack (7) and a second series mode selection unit (47). The DC power output terminal of the fourth fuel cell stack (7) includes a fourth positive DC power output terminal (71) and a fourth negative DC power output terminal (72), the fourth positive DC power output terminal (71) and the fourth negative DC power output terminal (72) being respectively the cathode and the anode of the DC power of the fourth fuel cell stack (7), and the fourth fuel cell stack (7) being electrically connected to the series-parallel circuit unit (4) via the fourth positive DC power output terminal (71) and the fourth negative DC power output terminal (72). The second series mode selection unit (47) selects the electrical connection relationship between the first fuel cell stack (1), the fourth fuel cell stack (7) and the first parallel mode selection unit (41), and selects whether the series-connected first fuel cell stack (1) and the fourth fuel cell stack (7) are electrically connected or disconnected in coordination with the action of the first parallel mode selection unit (41) of the first fuel cell stack (1). In a specific example, the second series mode selection unit (47) includes four electrical connection ends and electrical connect/disconnect switches (not shown in the figure) between the ends. One end of the second series mode selection unit (47) is electrically connected to the first positive DC power output terminal (11) of the first fuel cell stack (1), another end is electrically connected to the fourth negative DC power output terminal (72) of the fourth fuel cell stack (7), yet another end is electrically connected to the fourth positive DC power output terminal (71), and yet another end is electrically connected to the first parallel mode selection unit (41). The second series mode selection unit (47) could simultaneously select whether the fourth negative DC power output terminal (72) of the fourth fuel cell stack (7) and the first positive DC power output terminal (11) of the first fuel cell stack (1) are electrically connected or disconnected, and select whether the fourth positive DC power output terminal (71) of the fourth fuel cell stack (7) and the first parallel mode selection unit (47) are electrically connected or disconnected. Or the second series mode selection unit (47) could select whether the first positive DC power output terminal (11) of the first fuel cell stack (1) and the first parallel mode selection unit (41) are electrically connected or disconnected.

When the control unit (6) controls simultaneously the second series mode selection unit (47) to select the fourth negative DC power output terminal (72) of the fourth fuel cell stack (7) and the first positive DC power output terminal (11) of the first fuel cell stack (1) being electrically connected, the second series mode selection unit (47) to select the first positive DC power output terminal (11) of the first fuel cell stack (1) and the first parallel mode selection unit (41) being electrically disconnected, the first parallel mode selection unit (41) to select the fourth positive DC power output terminal (71) of the fourth fuel cell stack (7) and the positive integrated DC power output terminal (44) being electrically connected, and the first parallel mode selection unit (41) to select the first negative DC power output terminal (12) of the first fuel cell stack (1) and the negative integrated DC power output terminal (45) being electrically connected, the first fuel cell stack (1) and the fourth fuel cell stack (7) form a series connection, and are respectively electrically connected to the positive integrated DC power output terminal (44) and the negative integrated DC power output terminal (45) via the fourth positive DC power output terminal (71) of the fourth fuel cell stack (7) and the first negative DC power output terminal (12) of the first fuel cell stack (1), while the, second fuel cell stack (2) and the third fuel cell stack (3) are electrically connected in parallel. Hence after the first fuel cell stack (1) and the fourth fuel cell stack (7) form a series connection, they are electrically connected to the second fuel cell stack (2) and the third fuel cell stack (3) in parallel.

In addition, when the control unit (6) controls simultaneously the second series mode selection unit (47) to select the fourth negative DC power output terminal (72) of the fourth fuel cell stack (7) and the first positive DC power output terminal (11) of the first fuel cell stack (1) being electrically disconnected, the second series mode selection unit (47) to select the first positive DC power output terminal (11) of the first fuel cell stack (1) and the first parallel mode selection unit (41) being electrically connected, the first parallel mode selection unit (41) to select the first negative DC power output terminal (12) of the first fuel cell stack (1) and the negative integrated DC power output terminal (45) being electrically connected, the first fuel cell stack (1), the second fuel cell stack (2) and the third fuel cell stack (3) are electrically connected in parallel, while the fourth fuel cell stack (7) will not output power to the positive integrated DC power output terminal (44) or the negative integrated DC power output terminal (45).

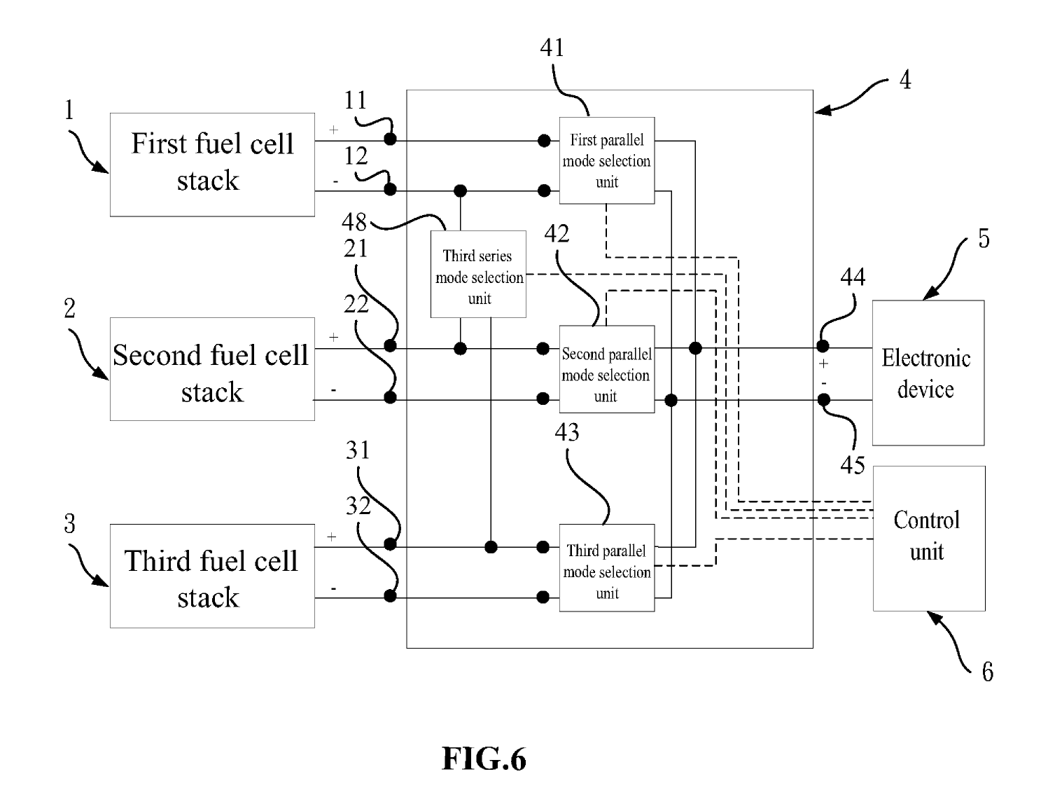

FIG. 6 is a component diagram of a fuel cell system with series-parallel circuit according to a sixth embodiment of the invention. In this embodiment, the fuel cell system with series-parallel circuit further comprises a third series mode selection unit (48), the third series mode selection unit (48) selecting whether two of the plurality of fuel cell stacks are electrically connected or disconnected, and coordinating with the first parallel mode selection unit (41) corresponding to the first fuel cell stack (1), the second parallel mode selection unit (42) corresponding to the second fuel cell stack (2), and the third parallel mode selection unit (43) corresponding to the third fuel cell stack (3) enable the third series mode selection unit (48) to select whether the series-connected first fuel cell stack (1) and second fuel cell stack (2) are electrically connected or disconnected, or enable the third series mode selection unit (48) to select whether the series-connected first fuel cell stack (1) and third fuel cell stack (3) are electrically connected or disconnected. In a specific example, the third series mode selection unit (48) is a three-end connection switching element with one end being electrically connected to the first negative DC power output terminal (12) of the first fuel cell stack (1), another end being electrically connected to the second positive DC power output terminal (21) of the second fuel cell stack (2), and yet another end being electrically connected to the third positive DC power output terminal (31) of the third fuel cell stack (3). The third series mode selection unit (48) could select whether the first negative DC power output terminal (12) of the first fuel cell stack (1) and the second positive DC power output terminal (21) of the second fuel cell stack (2) are electrically connected or disconnected, or select whether the first negative DC power output terminal (12) of the first fuel cell stack (1) and the third positive DC power output terminal (31) of the third fuel cell stack (3) are electrically connected or disconnected.

Hence when the control unit (6) controls simultaneously the third series mode selection unit (48) to select the first negative DC power output terminal (12) of the first fuel cell stack (1) and the second positive DC power output terminal (21) of the second fuel cell stack (2) being electrically connected, the first parallel mode selection unit (41) to select the first positive DC power output terminal (11) of the first fuel cell stack (1) and the positive integrated DC power output terminal (44) being electrically connected, the first parallel mode selection unit (41) to select the first negative DC power output terminal (12) of the first fuel cell stack (1) and the negative integrated DC power output terminal (45) being electrically disconnected, the second parallel mode selection unit (42) to select the second positive DC power output terminal (21) of the second fuel cell stack (2) and the positive integrated DC power output terminal (44) being electrically disconnected, and the second parallel mode selection unit (42) to select the second negative DC power output terminal (22) of the second fuel cell stack (2) and the negative integrated DC power output terminal (45) being electrically connected, the first fuel cell stack (1) and the second fuel cell stack (2) form a series connection, and are respectively electrically connected to the positive integrated DC power output terminal (44) and the negative integrated DC power output terminal (45) via the first positive DC power output terminal (11) of the first fuel cell stack (1) and the second negative DC power output terminal (22) of the second fuel cell stack (2), and at the same time form a parallel-connection with the third fuel cell stack (3).

In addition, when the control unit (6) controls simultaneously the third series mode selection unit (48) to select the first negative DC power output terminal (12) of the first fuel cell stack (1) and the third positive DC power output terminal (31) of the third fuel cell stack (3) being electrically connected, the first parallel mode selection unit (41) to select the first positive DC power output terminal (11) of the first fuel cell stack (1) and the positive integrated DC power output terminal (44) being electrically connected, the first parallel mode selection unit (41) to select the first negative DC power output terminal (12) of the first fuel cell stack (1) and the negative integrated DC power output terminal (45) being electrically disconnected, the third parallel mode selection unit (43) to select the third positive DC power output terminal (31) of the third fuel cell stack (3) and the positive integrated DC power output terminal (44) being electrically disconnected, and the third parallel mode selection unit (43) to select the third negative DC power output terminal (32) of the third fuel cell stack (3) and the negative integrated DC power output terminal (45) being electrically connected, the first fuel cell stack (1) and the third fuel cell stack (3) form a series connection, and are respectively electrically connected to the positive integrated DC power output terminal (44) and the negative integrated DC power output terminal (45) via the first positive DC power output terminal (11) of the first fuel cell stack (1) and the third negative DC power output terminal (32) of the third fuel cell stack (3), and at the same time form a parallel-connection with the second fuel cell stack (2).

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A fuel cell system with series-parallel circuit, comprising:
a plurality of fuel cell stacks, each fuel cell stack consisting of DC power output terminals;
a series-parallel circuit unit consisting of a plurality of parallel mode selection units and DC power output terminals; and
a control unit for controlling the actions of parallel mode selection units in the series-parallel circuit unit;
wherein the DC power output terminal of respective fuel cell stack is electrically connected to the corresponding parallel mode selection unit in the series-parallel circuit unit, the parallel mode selection units are electrically parallel-connected to the DC power output terminal of the series-parallel circuit unit, and the parallel mode selection unit selects whether the DC power output terminal of the corresponding fuel cell stack and the DC power output terminal of the series-parallel circuit unit are electrically connected or disconnected.

2. The fuel cell system with series-parallel circuit according to claim 1, wherein the plurality of fuel cell stacks include a first fuel cell stack, the first fuel cell stack consisting of a fuel cell member and a DC voltage conversion unit corresponding to the fuel cell member, and the DC power output terminals of the first fuel cell stack outputting power converted by the DC voltage conversion unit.

3. The fuel cell system with series-parallel circuit according to claim 1, wherein the first fuel cell stack comprise a plurality of fuel cell members and a plurality of DC voltage conversion units corresponding to the fuel cell members, each fuel cell member being a power generating member and outputting DC power to the DC voltage conversion unit, the DC voltage conversion unit converting the input DC power into DC power with specific voltage for output; and the DC power output terminals of the DC voltage conversion units forming a series-connection and the DC power output terminals of the first fuel cell stack outputting the integrated power from the series-connected DC voltage conversion units.

4. The fuel cell system with series-parallel circuit according to claim 1, wherein the DC power output terminals of the series-parallel circuit unit consist of a positive integrated DC power output terminal and a negative integrated DC power output terminal; the fuel cell stacks comprises a first fuel stack and a second fuel cell stack, the DC power output terminals of the first fuel cell stack consist of a first positive DC power output terminal and a first negative DC power output terminal, the DC power output terminals of the second fuel cell stack consist of a second positive DC power output terminal and a second negative DC power output terminal; and the parallel mode selection units consist of a first parallel mode selection unit and a second parallel mode selection unit, the first parallel mode selection unit and the second parallel mode selection unit being respectively electrically connected to the first fuel cell stack and the second fuel cell stack, and electrically parallel-connected to the positive integrated DC power output terminal and the negative integrated DC power output terminal of the series-parallel circuit unit;
wherein the first parallel mode selection unit selects whether the first positive DC power output terminal of the first fuel cell stack and the positive integrated DC power output terminal are electrically connected or disconnected, or selects whether the first negative DC power output terminal of the first fuel cell stack and the negative integrated DC power output terminal are electrically connected or disconnected; and
the second parallel mode selection unit selects whether the second positive DC power output terminal of the second fuel cell stack and the positive integrated DC power output terminal are electrically connected or disconnected, or selects whether the second negative DC power output terminal of the second fuel cell stack and the negative integrated DC power output terminal are electrically connected or disconnected.

5. The fuel cell system with series-parallel circuit according to claim 1, wherein the plurality of fuel cell stacks comprise a first fuel cell stack and a second fuel cell stack; and the series-parallel circuit unit further comprises a series mode selection unit, a first parallel mode selection unit and a second parallel mode selection unit, the first parallel mode selection unit and the second parallel mode selection unit being respectively electrically connected to the first fuel cell stack and the second fuel cell stack, and the first parallel mode selection unit and the second parallel mode selection unit being electrically parallel-connected to the DC power output terminal of the series-parallel circuit unit;
wherein the control unit further controls the actions of the series mode selection units of the series-parallel circuit unit; the series mode selection unit selects the first fuel cell stack and the second fuel cell stack being in the state of electrically connected in series, and the first parallel mode selection unit and the second parallel mode selection unit select the electrical loop comprising the series-connected first fuel cell stack and second fuel cell stack being electrically parallel-connected to the DC power output terminal of the series-parallel circuit unit; or the series mode selection unit selects the series-connected first fuel cell stack and the second fuel cell stack being electrically disconnected from each other.

6. The fuel cell system with series-parallel circuit according to claim 5, wherein the plurality of fuel cell stacks further comprise a third fuel cell stack; and the series-parallel circuit unit further comprises a third parallel mode selection unit, the third parallel mode selection unit being electrically connected to the third fuel cell stack;
wherein the series mode selection unit further selects the first fuel cell stack and the third fuel cell stack being in the state of electrically connected in series, and the first parallel mode selection unit and the third parallel mode selection unit select the electrical loop comprising the series-connected first fuel cell stack and third fuel cell stack being electrically parallel-connected to, the DC power output terminal of the series-parallel circuit unit; or the series mode selection unit further selects the series-connected first fuel cell stack and the third fuel cell stack being electrically disconnected from each other.

7. The fuel cell system with series-parallel circuit according to claim 1, wherein the plurality of fuel cell stacks comprise a first fuel cell stack and a second fuel cell stack; and the series-parallel circuit unit further comprises a series mode selection unit and a parallel mode selection unit, the series mode selection unit being electrically connected to the first fuel cell stack and the second fuel cell stack;
wherein the control unit further controls the actions of the series mode selection units of the series-parallel circuit unit; the series mode selection unit selects the first fuel cell stack and the second fuel cell stack being in the state of electrically connected in series, and the parallel mode selection unit select the series-connected first fuel cell stack and second fuel cell stack being electrically parallel-connected to the DC power output terminal of the series-parallel circuit unit; or the series mode selection unit selects the series-connected first fuel cell stack and second fuel cell stack being electrically disconnected from each other, and the parallel mode selection unit selects the first fuel cell stack being electrically parallel-connected to the DC power output terminal of the series-parallel circuit unit.

8. The fuel cell system with series-parallel circuit according to claim 1, wherein the control unit has a logic control means needed for the operation of the fuel cell system with series-parallel circuit and is composed of a logic circuit or a chip coupled with firmware.
